(19) United States
(12) Patent Application Publication
(10) Pub. No.: US 2013/0051277 A1
(43) Pub. Date: Feb. 28, 2013

(54) METHOD AND APPARATUS FOR ALLOCATING RESOURCES FOR DEVICE-TO-DEVICE DISCOVERY

(71) Applicants: Sami-Jukka Hakola, Kempele (FI); Timo Koskela, Oulu (FI); Samuli Turtinen, Ii (FI)

(72) Inventors: Sami-Jukka Hakola, Kempele (FI); Timo Koskela, Oulu (FI); Samuli Turtinen, Ii (FI)

(73) Assignee: RENESAS MOBILE CORPORATION, Tokyo (JP)

(21) Appl. No.: 13/221,343

(22) Filed: Aug. 30, 2011

(51) Int. Cl. H04L 12/28

(52) U.S. Cl. 370/254

(57) ABSTRACT

A method and apparatus for providing allocating efficient resource allocation for device-to-device (D2D) communications. Various bandwidth allocations are provided which provide for D2D discovery information to be included on a time slot, such as an uplink pilot time slot (UpPTS). By accommodating D2D discovery information on un-used available bandwidth, the base station may efficiently configure and assign radio resources for D2D and cluster communication purposes in its coverage area.

### TECHNOLOGICAL FIELD

Embodiments of the present invention relate generally to wireless communication technology and, more particularly, to a method and apparatus for providing efficient resource allocation for device-to-device (D2D) discovery.

### BACKGROUND

The Third Generation Partnership Project (3GPP) Long Term Evolution (LTE) specification is a set of enhancements to the universal mobile telecommunications system (UMTS) which was introduced in Release 8. Device-to-Device (“D2D”) communications are included in these enhancements, and involve two telecommunications devices communicating directly with each other via a communication link such as a radio link.

Providing for D2D communications in a wireless network presents several advantages, including reducing the bandwidth requirements of the wireless network which can then be used to accommodate more wireless network users or support larger bandwidth applications. Within its coverage are, a base station, such as an enhanced Node B (eNB), configures and assigns radio resources for D2D and cluster communication purposes including both beaconing and data communication. In this regard, various different signaling methods have been proposed for the resource allocation. In this regard, the eNB may use a similar resource allocation for the D2D and cluster communication devices as for cellular user by utilizing downlink control information (DCI) messages on the physical downlink control channel (PDCCH). In this regard, each D2D pair or cluster may be assigned a unique radio network temporary identifier (RNTI) that is utilized to signal resources, or a common RNTI may be shared. Alternatively, an eNB may broadcast unused resources in its cell so that D2D devices or clusters may then utilize the unused resources in an autonomous manner. However, it would be desirable to provide improvements in the allocation of resources for D2D devices in a manner that allows operators to retain control of the device behavior, such as by controlling which devices can emit discovery signal, when and where such discovery signals are emitted, what information is carried by the discovery signals and what devices should do once the devices have discovered one another.

### BRIEF SUMMARY

Therefore, to address the needs and deficiencies described above, methods and apparatus are provided according to the example embodiments for providing for the allocation of resources for D2D discovery in an efficient manner by allocating un-used portions of bandwidth for D2D discovery information. In one example embodiment, a method comprises initiating a D2D discovery function between a first device and a second device; ascertaining available bandwidth in a time slot, such as an uplink pilot time slot (UpPTS); determining the length of the time slot, such as the symbol length; and allocating a D2D discovery portion for a D2D connection based at least in part on the available bandwidth and the length of the time slot.

In another example embodiment, a method comprises allocating a first portion of system bandwidth in a timeslot, such as an uplink pilot timeslot (UpPTS), for resources for supporting device to device (D2D) discovery by a first device; and designating a second portion of the system bandwidth in the timeslot for resources for supporting D2D discovery by a second device such that the first and second devices are configured for D2D communication. The first portion and the second portion may be separated by bandwidth allocated for other resources.

In other example embodiments, an apparatus is provided. In one such example embodiment, an apparatus comprises at least one processor; and at least one memory including computer program code, the at least one memory and the computer program code configured to, with the at least one processor, cause the apparatus at least to: initiate a device to device (D2D) discovery function between a first device and a second device; ascertain available bandwidth in a time slot; determine the length of the time slot, such as the symbol length; and allocate a D2D discovery portion for a D2D connection based at least in part on the available bandwidth and the length of the time slot.

In another example embodiment, an apparatus is provided comprising at least one processor; and at least one memory including computer program code, with the at least one memory and the computer program code configured to, with the at least one processor, cause the apparatus at least to allocate a first portion of system bandwidth in a timeslot, such as an UpPTS, for resources for supporting device to device (D2D) discovery by a first device; and designate a second portion of the system bandwidth in the timeslot for resources for supporting D2D discovery by a second device such that the first and second devices are configured for D2D communication. The first portion and the second portion are separated by bandwidth allocated for other resources.

In one example embodiment, a computer program product is provided that includes at least one non-transitory computer-readable storage medium having computer-readable program instructions stored therein with the computer-readable program instructions including program instructions configured to initiate a D2D discovery function between a first device and a second device; ascertain available bandwidth in a time slot, such as an uplink pilot time slot (UpPTS); determine the length of the time slot, such as the symbol length; and allocate a D2D discovery portion for a D2D connection based at least in part on the available bandwidth and the length of the time slot.

In another example embodiment, a computer program product is provided that includes at least one non-transitory computer-readable storage medium having computer-readable program instructions stored therein with the computer-readable program instructions including program instructions configured to allocate a first portion of system bandwidth in a timeslot, such as an uplink pilot timeslot (UpPTS), for resources for supporting device to device (D2D) discovery by a first device; and designate a second portion of the system bandwidth in the timeslot for resources for supporting D2D discovery by a second device such that the first and second devices are configured for D2D communication. The first portion and the second portion may be separated by bandwidth allocated for other resources.

In a further example embodiment, an apparatus is provided that includes means for initiating a D2D discovery function between a first device and a second device; means for ascertaining available bandwidth in a time slot, such as an uplink pilot time slot (UpPTS); means for determining the length of the time slot, such as the symbol length; and means for allocating a D2D discovery portion for a D2D connection based at least in part on the available bandwidth and the length of the time slot.

In another example embodiment, an apparatus is provided that includes means for allocating a first portion of system bandwidth in a timeslot, such as an uplink pilot timeslot (UpPTS), for resources for supporting device to device (D2D) discovery by a first device; and means for designating a second portion of the system bandwidth in the timeslot for resources for supporting D2D discovery by a second device such that the first and second devices are configured for D2D communication. The first portion and the second portion may be separated by bandwidth allocated for other resources.

### BRIEF DESCRIPTION OF THE SEVERAL VIEWS OF THE DRAWINGS

Having thus described embodiments of the invention in general terms, reference will now be made to the accompanying drawings, which are not necessarily drawn to scale, and wherein:

FIG. 1 is one example of a communications system according to an embodiment of the present invention.

FIG. 2 is a block diagram of an apparatus from the perspective of the base station in accordance with an example embodiment of the present invention.

FIG. 3 is a block diagram of a bandwidth allocation from the perspective of a mobile terminal in accordance with an embodiment of the present invention.

FIGS. 4-8 are block diagrams of the bandwidth allocations in accordance with several embodiments of the present invention.

FIGS. 9-11 are flowcharts illustrating the various bandwidth allocation methods performed in accordance with several example embodiments of the present invention from the perspective of a mobile terminal.

FIG. 12 is a block diagram of additional bandwidth allocations in accordance with several embodiments of the present invention.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

The term ‘circuitry’ refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform the various functions) and (c) to circuits, such as microprocessor(s) or a portion of microprocessor(s), that require software or firmware for operation, even if the software or firmware is not present.

This definition of ‘circuitry’ applies to all uses of this term in this application, including any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, sensor circuitry to provide one or more sensing functions, a subscriber identity module (SIM) memory device or SIM card, a baseband integrated circuit or applications processor integrated circuit for a mobile phone or similar integrated circuit in a server, a cellular network device, or other network device.

In accordance with an example embodiment of the present invention, a communication system is provided in which a network entity, such as a base station, e.g., an access point, a Node B, an evolved Node B (eNB) or the like, may communicate with one or more mobile terminals 14 and 16, such as via a cellular or other wireless network. The mobile terminals 14 and 16 may be capable of communication, such as cellular communication, in the licensed band with a network 10 (e.g., a communication network such as a core network, wireless sensor network (WSN) network, or any other communication system) and with each other via a device-to-device connection (shown by lightening bolts). While the network may be configured in accordance with the Long Term Evolution (LTE) or Zigbee specifications, the network may employ other mobile access mechanisms such as wideband code division multiple access (W-CDMA), CDMA2000, global system for mobile communications (GSM), general packet radio service (GPRS), LTE-Advanced (LTE-A) and/or the like.

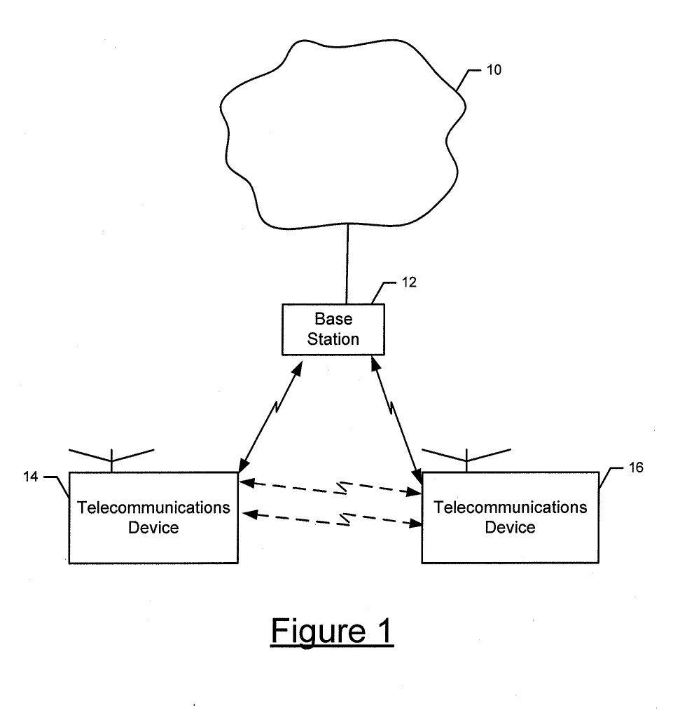

The network 10 may include a collection of various different nodes, network entities, members, devices or functions that may be in communication with each other via corresponding wired and/or wireless interfaces. As such, the illustration of FIG. 1 should be understood to be an example of a broad view of certain elements of the system and not an all inclusive or detailed view of the system or the network. The base station 12 could be, for example, part of one or more cellular or mobile networks or public land mobile networks (PLMNs). In turn, other devices such as processing devices (e.g., personal computers, server computers or the like) may be coupled to the terminals via the network.

In some example embodiments, the mobile terminals 14 and 16 may be, for example, a number of devices, including without limitation, a mobile telephone, portable digital assistant (PDA), pager, laptop computer, or any of numerous other hand held or portable communication devices, computation devices, content generation devices, content consumption devices, or combinations thereof. Regardless of the type of device, the mobile terminal 14 may include one or more processors that may define processing circuitry either alone or in combination with one or more memories, such as a flash electrically eraseable programmable read only memory (EEPROM) memory. The processing circuitry may utilize instructions stored in the memory to cause the mobile terminal 14 to operate in a particular way or execute specific functionality when the instructions are executed by the one or more processors. The mobile terminal 14 may also include communication circuitry and corresponding hardware/software to enable communication with the network 10.

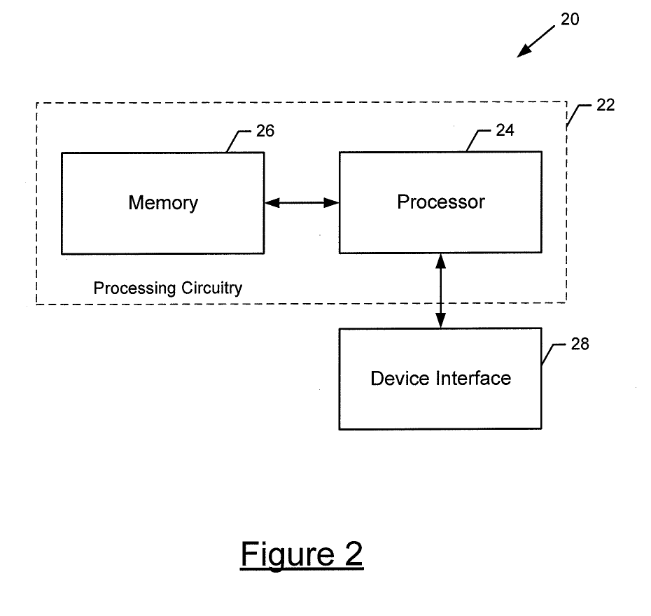

The base station 12 may be embodied as or otherwise include an apparatus 20 as generically represented by the block diagram of FIG. 2. While one embodiment of the apparatus is illustrated and described below, it should be noted that the components, devices or elements described below may not be mandatory and thus some may be omitted in certain embodiments. Additionally, some embodiments may include further or different components, devices or elements beyond those shown and described herein.

As shown in FIG. 2, the apparatus 20 may include or otherwise be in communication with processing circuitry 22 that is configurable to perform actions in accordance with example embodiments described herein. The processing circuitry 22 may be configured to manage D2D communications between mobile terminals such as mobile terminal 14 and mobile terminal 16, perform data processing, application execution and/or other processing and management services according to an example embodiment of the present invention. In some embodiments, the apparatus or the processing circuitry 22 may be embodied as a chip or chip set. In other words, the apparatus or the processing circuitry 22 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus or the processing circuitry 22 may therefore, in some cases, be configured to implement an embodiment of the present invention on a single chip or as a single “system on a chip.” As such, in some cases, a chip or chipset may constitute means for performing one or more operations for providing the functionalities described herein.

In an example embodiment, the processing circuitry 22 may include a processor 24 and memory 26 that may be in communication with or otherwise control a device interface 28. As such, the processing circuitry 22 may be embodied as a circuit chip (e.g., an integrated circuit chip) configured (e.g., with hardware, software or a combination of hardware and software) to perform operations described herein in relation to the base station 12. The device interface 28 may include one or more interface mechanisms for enabling communication with other devices, such as the mobile terminal 14, mobile terminal 16, and/or networks, such as network 10. In some cases, the device interface may be any means such as a device or circuitry embodied in either hardware, or a combination of hardware and software that is configured to receive and/or transmit data from/to a network and/or any other device or module in communication with the processing circuitry 22. In this regard, the device interface may include, for example, an antenna (or multiple antennas) and supporting hardware and/or software for enabling communications with a wireless communication network and/or a communication modem, such as a cellular modem, for enabling communications with the first and second mobile terminals.

In an example embodiment, the memory 26 may include one or more non-transitory memory devices such as, for example, volatile and/or non-volatile memory that may be either fixed or removable (including without limitation flash EEPROM memory). The memory may be configured to store information (such as, without limitation, a network topology map in accordance with several example embodiments of the present invention), data, applications, instructions or the like for enabling the apparatus 20 to carry out various functions in accordance with example embodiments of the present invention. For example, the memory could be configured to buffer input data for processing by the processor 24. Additionally or alternatively, the memory could be configured to store instructions for execution by the processor. Among the contents of the memory, applications may be stored for execution by the processor in order to carry out the functionality associated with each respective application. In some cases, the memory may be in communication with the processor via a bus for passing information among components of the apparatus.

The processor 24 may be embodied in a number of different ways. For example, the processor may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. In an example embodiment, the processor may be configured to execute instructions stored in the memory 26 or otherwise accessible to the processor. As such, whether configured by hardware or by a combination of hardware and software, the processor may represent an entity (e.g., physically embodied in circuitry—in the form of processing circuitry 22) capable of performing operations according to embodiments of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the operations described herein.

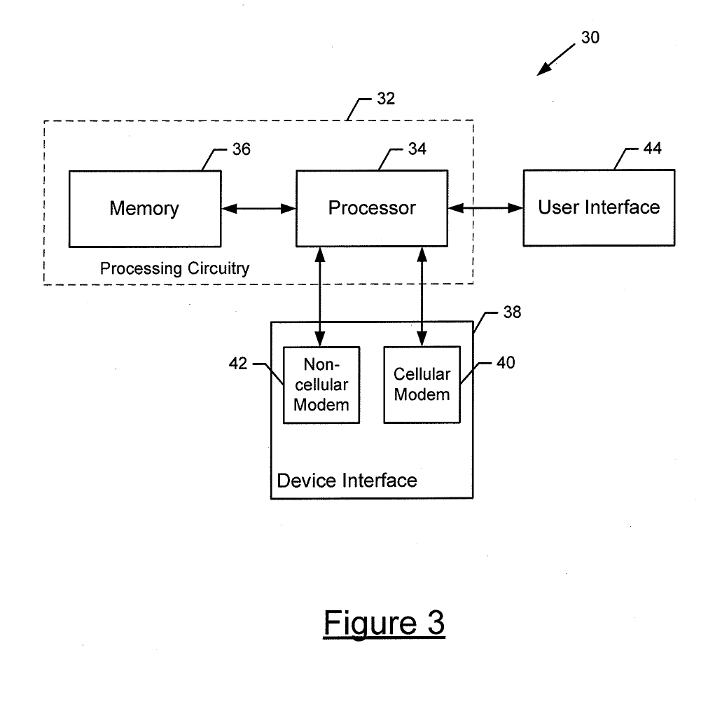

In one embodiment, the mobile terminal 14 or the mobile terminal 16 may be embodied as or otherwise include an apparatus 30 as generically represented by the block diagram of FIG. 3. In this regard, the apparatus may be configured to provide for cellular communications with the network 10 via the base station 12 and for non-cellular communications with another mobile terminal via a device-to-device connection in the license exempt band. While the apparatus may be employed, for example, by a mobile terminal 14, it should be noted that the components, devices or elements described below may not be mandatory and thus some may be omitted in certain embodiments. Additionally, some embodiments may include further or different components, devices or elements beyond those shown and described herein.

As shown in FIG. 3, the apparatus 30 may include or otherwise be in communication with processing circuitry 32 that is configurable to perform actions in accordance with example embodiments described herein. The processing circuitry 32 may be configured to perform data processing, application execution and/or other processing and management services according to an example embodiment of the present invention. In some embodiments, the apparatus or the processing circuitry 32 may be embodied as a chip or chip set. In other words, the apparatus or the processing circuitry 32 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus or the processing circuitry 32 may therefore, in some cases, be configured to implement an embodiment of the present invention on a single chip or as a single “system on a chip.” As such, in some cases, a chip or chipset may constitute means for performing one or more operations for providing the functionalities described herein.

In an example embodiment, the processing circuitry 32 may include a processor 34 and memory 36 that may be in communication with or otherwise control a device interface 38 and, in some cases, a user interface 44. As such, the processing circuitry 32 may be embodied as a circuit chip (e.g., an integrated circuit chip) configured (e.g., with hardware, software or a combination of hardware and software) to perform operations described herein. However, in some embodiments taken in the context of some telecommunications devices such as a mobile terminal, the processing circuitry 32 may be embodied as a portion of a mobile computing device or other device. The processing circuitry 32 may also include a SIM memory device 35, such as a SIM card or other integrated circuit that securely stores a service-subscriber key (IMSI) used to identify a subscriber on telecommunications devices such as, without limitation, mobile terminals.

The user interface 44 (if implemented) may be in communication with the processing circuitry 32 to receive an indication of a user input at the user interface and/or to provide an audible, visual, mechanical or other output to the user. As such, the user interface may include, for example, a keyboard, a mouse, a joystick, a display, a touch screen, a microphone, a speaker, and/or other input/output mechanisms.

The device interface 38 may include one or more interface mechanisms for enabling communication with other devices, such as aother telecommunication devices 16, e.g., mobile terminals, and/or networks, such as network 10 via base station 12. In some cases, the device interface may be any means such as a device or circuitry embodied in either hardware, or a combination of hardware and software that is configured to receive and/or transmit data from/to a network and/or any other device or module in communication with the processing circuitry 32. In this regard, the device interface may include, for example, an antenna (or multiple antennas) and supporting hardware and/or software for enabling communications with a wireless communication network and/or a communication modem or other hardware/software for supporting communication via cable, digital subscriber line (DSL), universal serial bus (USB), Ethernet or other methods. In the illustrated embodiment, for example, the device interface includes a cellular modem 40 for supporting communications in the licensed spectrum, such as communications with the base station 12, and a non-cellular modem 42 for supporting communications in the license exempt band, such as non-cellular communications, e.g., device to device communications.

In an example embodiment, the memory 36 may include one or more non-transitory memory devices such as, for example, volatile and/or non-volatile memory that may be either fixed or removable. The memory may be configured to store information, data, applications, instructions or the like for enabling the apparatus 30 to carry out various functions in accordance with example embodiments of the present invention. For example, the memory could be configured to buffer input data for processing by the processor 34. Additionally or alternatively, the memory could be configured to store instructions for execution by the processor. As yet another alternative, the memory may include information relating to a D2D communication link. Among the contents of the memory, applications may be stored for execution by the processor in order to carry out the functionality associated with each respective application. In some cases, the memory may be in communication with the processor via a bus for passing information among components of the apparatus.

The processor 34 may be embodied in a number of different ways. For example, the processor may be embodied as various processing means such as one or more of a microprocessor or other processing element, a coprocessor, a controller or various other computing or processing devices including integrated circuits such as, for example, an ASIC, an FPGA or the like. In an example embodiment, the processor may be configured to execute instructions stored in the memory 36 or otherwise accessible to the processor. As such, whether configured by hardware or by a combination of hardware and software, the processor may represent an entity (e.g., physically embodied in circuitry—in the form of processing circuitry 32) capable of performing operations according to embodiments of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the operations described herein.

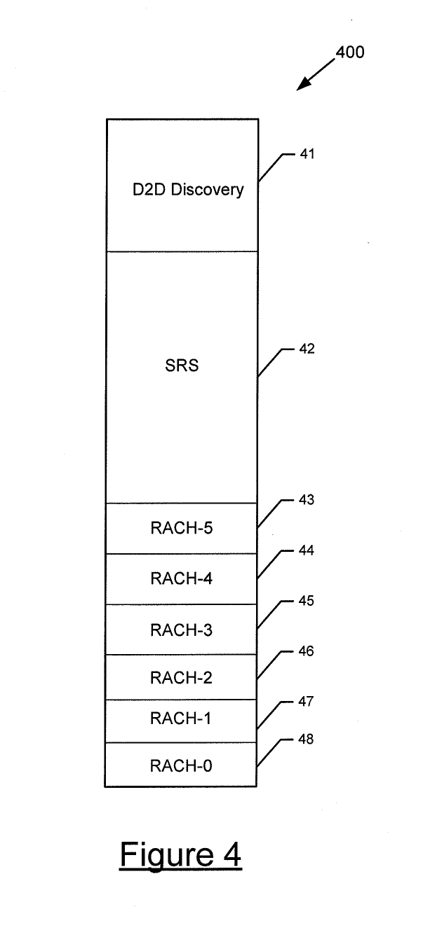

FIGS. 4-8 are block diagrams of the bandwidth allocations in accordance with several embodiments of the present invention. Each one of these bandwidth allocations shown in FIGS. 4-8 provide for the accommodation of D2D discovery information, which may be included in a D2D discovery portion, on available bandwidth, that is bandwidth within a timeslot that is unused or is otherwise available for use by a D2D discovery portion, such as in an instance in which the bandwidth is otherwise allocated to a relatively low priority purpose. This available bandwidth may vary depending on the other information provided via the bandwidth, including portions of the bandwidth dedicated to the random access channel (RACH). In each bandwidth allocation, each D2D discovery portion occupies unused bandwidth. Also, some of the bandwidth allocations shown below, as described, are utilized when only one D2D device has been detected, and other bandwidth allocations are utilized when more than one D2D device have been detected or when additional resources are desired to be allocated for D2D discovery information. In all bandwidth allocations shown in FIGS. 4-8, it should be understood that each D2D discovery portion may be further subdivided to accommodate more than one D2D device. Therefore, in FIGS. 4-8, if only one D2D discovery portion is shown, the one D2D discovery portion may include information relating to multiple D2D devices.

FIG. 4 illustrates a bandwidth allocation which is utilized when only one D2D discovery portion is needed, and a portion of the bandwidth is dedicated to the RACH. In this example embodiment, as shown in FIG. 4, system bandwidth 400 comprises at least the following allocated portions: D2D discovery portion, 41, sounding reference signal (SRS) portion 42, and RACH-0 to RACH-5 portions (43-48). As shown, the D2D discovery portion may be positioned proximate one end of the bandwidth such as opposite the RACH portions.

In this and other embodiments, the D2D discovery portion may include any D2D discovery information that may be utilized by the base station 12 in managing D2D devices or D2D communication links. For example, this D2D discovery information may include, without limitation, an identifier for a D2D device, a block list for determining which D2D devices can communicate with other D2D devices, model or unit information for a D2D device, or location information for a D2D device.

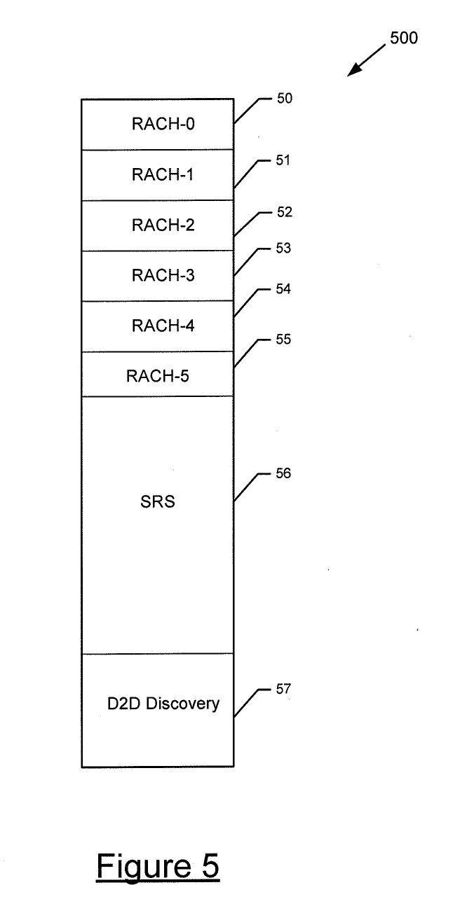

In one embodiment, the configuration of the allocated portions may change to a mirror image of the allocation in 400 in a subsequent timeslot, such as a subsequent uplink pilot time slot (UpPTS). As shown in the embodiment of FIG. 5, for example, RACH-0 to RACH-5 (50-55) are re-allocated to the top of the bandwidth in 500, and the D2D discovery portion 57 is re-allocated to the bottom of the bandwidth in 500. While RACH-0 to RACH 5 are shown, less RACH channels may be included in bandwidth 500, such as any number from 1-5 (RACH-0 to RACH-5). SRS 56 remains located in between the RACH-0 to RACH-5 portions (50-55) as in 400. This mirror imaging of the allocation and assignment of the RACH portions and the D2D discovery portions may continue to future time slots, with each allocation mirroring the previous time slot allocation, such as by switching the relative positions of the D2D discovery portion and the RACH portions by alternating, for example, between the allocations shown in FIGS. 4 and 5. The mirror imaging of the allocation and assignment of the RACH portions and the D2D portions occurs because, according to 3GPP specification 36.211 Physical Channels and Modulation (Chapter 5.7.1), the frequency domain multiplexing for RACH preamble format 4 alternate from one side of a bandwidth to other side of the bandwidth in subsequent uplink pilot time slots to enable efficient channel sounding (SRS transmission) over the whole channel bandwidth. Thus, according to this example embodiment, the D2D discovery portion also alternates from one side of the bandwidth to the other side of the bandwidth in subsequent uplink pilot time slots.

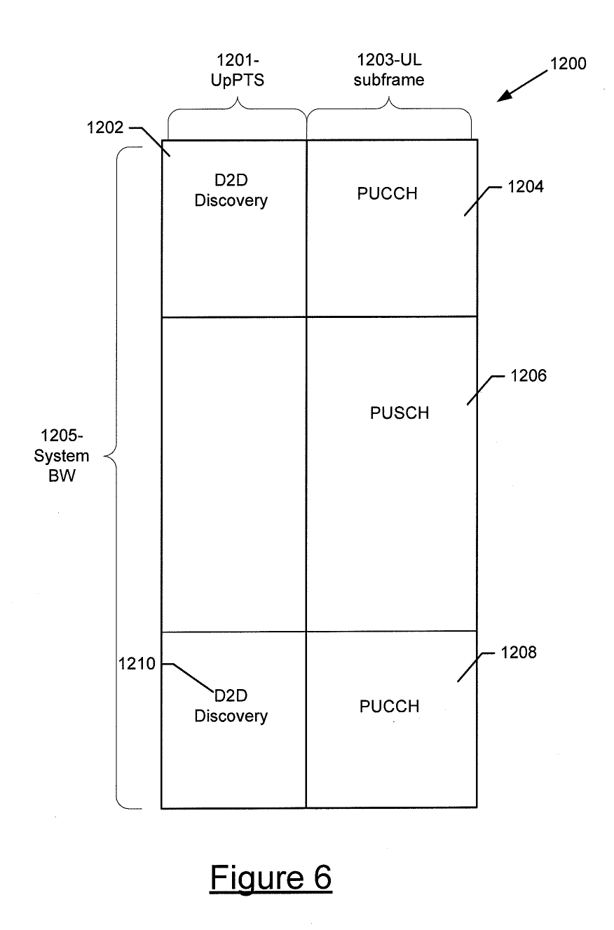

As shown in FIG. 6, time window 1200 is divided into UpPTS 1201 and uplink (UL) subframe 1203. Within the UpPTS, two resource slots are allocated for D2D discovery, the top slot 1202, and bottom slot 1210 in the system bandwidth (BW) 1205.

The PUCCH frequency resources 1204 and 1208 places the D2D discovery resources 1202 and 1210 at the channel edges, respectively, as shown in FIG. 6. In this and other example embodiments, the UL subframe 1203 comprises PUSCH and PUCCH in a stack configuration. For example, as shown in FIG. 6, the system bandwidth 1205 is allocated for PUSCH 1206 in the middle and PUCCH 1204 and 1208 are allocated at the top and bottom of the UL subframe 1203, respectively. PUSCH 1206 is allocated in between PUCCH 1204 and PUCCH 1208, wherein PUCCH 1204, PUSCH 1206, and PUCCH 1208 are allocated in a stack configuration.

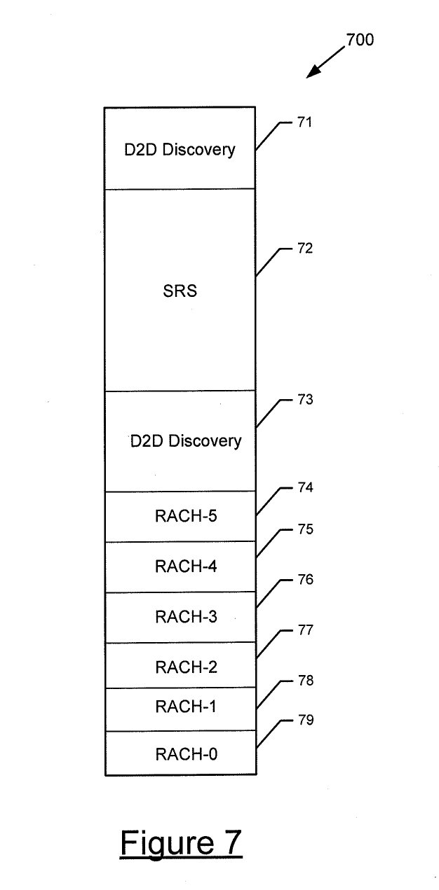

In FIG. 7, another bandwidth allocation is shown which provides for two D2D discovery portions along with RACH information. A first D2D discovery portion is provided in 71 adjacent one edge of the bandwidth. RACH-0 through RACH-5 are illustrated in 500 as occupying positions 74-79 adjacent the other edge of the bandwidth. In contrast to 400, immediately adjacent the RACH-0 through RACH-5 allocation is a second D2D discovery portion, 73. Thus, in contrast to allocation 400 which accommodates one D2D discovery portion, allocation 700 provides for 2 D2D discovery portions in the event that two D2D devices are present or additional D2D resource allocation is otherwise required.

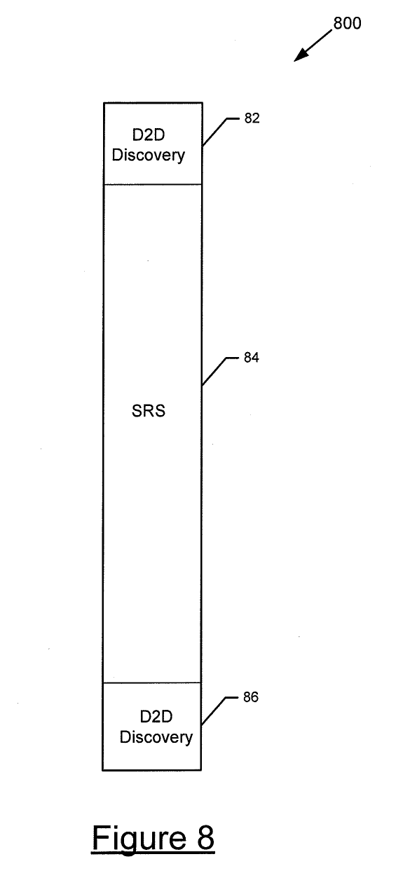

FIG. 8 illustrates a bandwidth allocation, according to an example embodiment when there are not any RACH portions on the bandwidth. Thus, in this situation, the bandwidth may be allocated for D2D resources as shown in 800 with two D2D discovey portions adjacent opposite edges of the bandwidth, as shown as 82 and 86. SRS is located in between the two discovery portions at 84 in the illustrated embodiment.

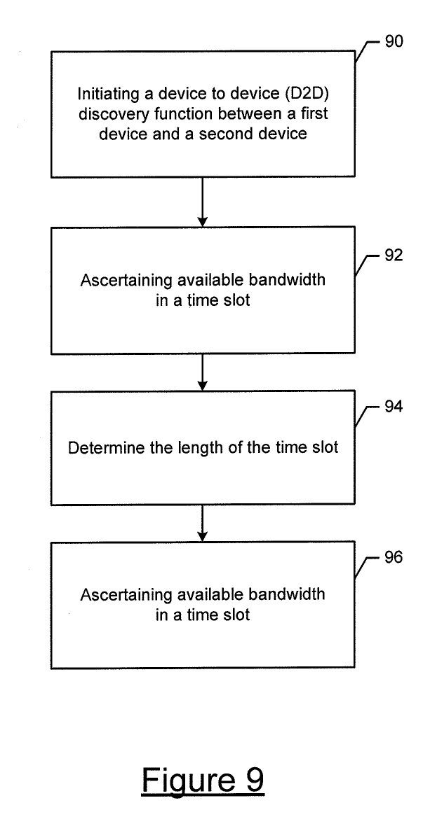

While example embodiments of the present invention have been described above in conjunction with FIGS. 1-8, flowcharts of the operations performed from the perspective of the mobile terminal 14 are now provided with reference to FIGS. 9-11. It will be understood that each block of the flowcharts, and combinations of blocks in the flowcharts, may be implemented by various means, such as hardware, firmware, processor, circuitry, and/or other device associated with execution of software including one or more computer program instructions. For example, one or more of the procedures shown by the flowcharts may be embodied by computer program instructions. In this regard, the computer program instructions which embody the procedures depicted by the flowcharts may be stored by a memory device of an apparatus employing an embodiment of the present invention and executed by a processor in the apparatus.

As will be appreciated, any such computer program instructions may be loaded onto a computer or other programmable apparatus (e.g., hardware) to produce a machine, such that the resulting computer or other programmable apparatus provides for implementation of the functions specified in the flowchart block(s). These computer program instructions may also be stored in a non-transitory computer-readable storage memory that may direct a computer or other programmable apparatus to function in a particular manner, such that the instructions stored in the computer-readable storage memory produce an article of manufacture, the execution of which implements the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions. It will also be understood that one or more blocks of the flowcharts, and combinations of blocks in the flowcharts, can be implemented by special-purpose hardware-based computer systems which perform the specified functions, or combinations of special purpose hardware and computer instructions.

In one example embodiment of the method of the present invention shown in FIG. 9, from the perspective of mobile terminal, an apparatus 30 may include means, such as the processing circuitry 32, the processor 34, the device interface 42 or the like, for initiating a device to device (D2D) discovery function between a first device and a second device, such as between respective mobile terminals. See block 90. This operation may comprise any number of actions, including receiving a signal or inquiry from a D2D device or receiving a request to initiate a D2D communication link with another D2D device, such as from the network and/or the other D2D device.

The apparatus 30 may also comprise means, such as the processing circuitry 32, the processor 34, the device interface 42 or the like, for ascertaining the available bandwidth in a time slot, which may comprise an uplink pilot time slot (UpPTS). See block 92. The available system bandwidth may comprise physical random access channel (PRACH) bandwidth or sounding reference signal (SRS) uplink bandwidth in a broadcast channel (BCH). The apparatus may further comprise means, such as the processing circuitry 32, the processor 34, the device interface 42 or the like, for determining the length of the time slot, which may comprise the symbol length. See block 94.

The apparatus 30 also comprises means, such as the processing circuitry 32, the processor 34 or the like, for allocating a D2D discovery portion based at least in part on the available bandwidth and the length of the time slot. See block 96. This allocation may be based at least in part on a physical resource access channel configuration information element if the length of the time slot is larger than one symbol.

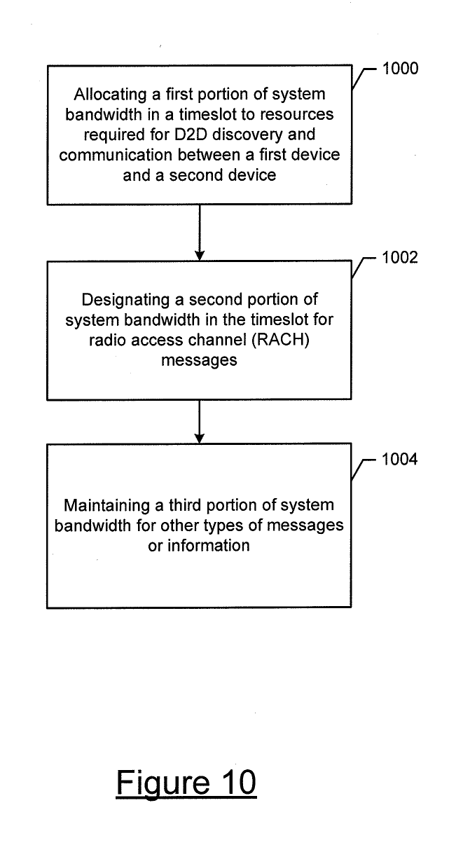

Another example embodiment of the method of the present invention is shown in FIG. 10, from the perspective of mobile terminal. As shown in FIG. 10, an apparatus 30 may comprise means, such as the processing circuitry 32, the processor 34 or the like, for allocating a first portion of system bandwidth in a timeslot to resources required for device to device discovery and communication between a first device and a second device, such as between a pair of mobile terminals. See block 1000. As discussed above, this D2D discovery portion may include D2D discovery information for one D2D device, or multiple D2D devices. Further, the D2D discovery portion may occupy unused or empty bandwidth that is not otherwise being used, such as for RACH messages or SRS. The apparatus may further include means, such as the processing circuitry 32, the processor 34 or the like, for designating a second portion of system bandwidth in the timeslot, such as in an UpPTS, for other types of messages, such as RACH messages. See block 1002. These RACH messages according to this example embodiment may comprise a first RACH message and a second RACH message, however, any number of RACH messages that may be accommodated on the bandwidth (such as bandwidth 700) may be present.

The apparatus 30 may further comprise means, such as the processing circuitry 32, the processor 34, the device interface 42 or the like, for maintaining a third portion of system bandwidth available for other types of messages or information. In one embodiment, the first portion, the second portion, and the third portion are configured in a stack configuration with each one adjacent to another within the bandwidth. The method in this example embodiment may further comprise allocating bandwidth in a subsequent time slot in a mirror-image stack configuration, such as with the first, second and third portions differently ordered, such as in an inverted manner as described above in conjunction with FIGS. 4 and 5. In this regard, the bandwidth allocation in the timeslots may alternate from one timeslot to the next with each timeslot having an allocation that is the mirror image of the adjacent timeslots.

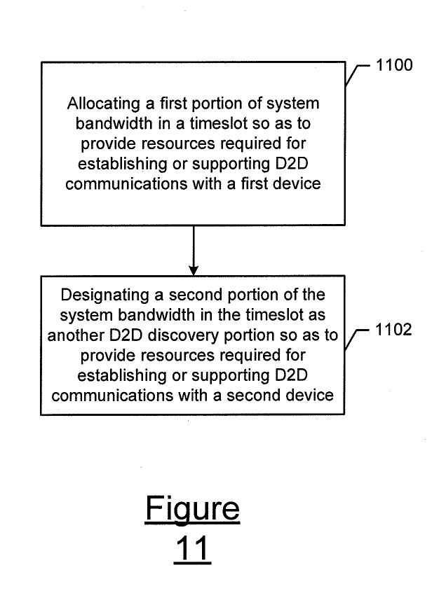

Yet another example embodiment of the method of the present invention is shown in FIG. 11, from the perspective of mobile terminal. According to this example embodiment, an apparatus 30 may include means, such as the processing circuitry 32, the processor 34 or the like, for allocating a first portion of system bandwidth in a time slot, such as an UpPTS, as a D2D discovery portion so as to provide resources required for establishing or supporting D2D communication with a first device, such as a mobile terminal. See block 1100. The D2D discovery portion may include D2D discovery information, which as previously described, may include without limitation indentifying information for a D2D device, model or serial number information for a D2D device, a block list identifying blocked D2D devices, or location information for a D2D device.

The apparatus 30 may further comprise means, such as the processing circuitry 32, the processor 34 or the like, for designating a second portion of the system bandwidth in the timeslot, such as an UpPTS, as another D2D discovery portion so as to provide resources required for establishing or supporting device to device communications with a second device, such as another mobile terminal. See block 1102. This second D2D discovery portion, as with other second D2D discovery portions described herein, may accommodate D2D information for either one D2D device or multiple D2D devices. Further, this second D2D discovery portion, as with the first D2D discovery portion, may also include D2D discovery information such as indentifying information for a D2D device, model or serial number information for a D2D device, a block list identifying blocked D2D devices, or location information for a D2D device.

The first D2D discovery portion and the second D2D discovery portion may be located adjacent to the available SRS bandwidth, such as at the opposed edges of the SRS bandwidth. In this and some other example embodiments, the available bandwidth may include bandwidth that is mapped to PUCCH resources, but is unused or is otherwise considered less important.

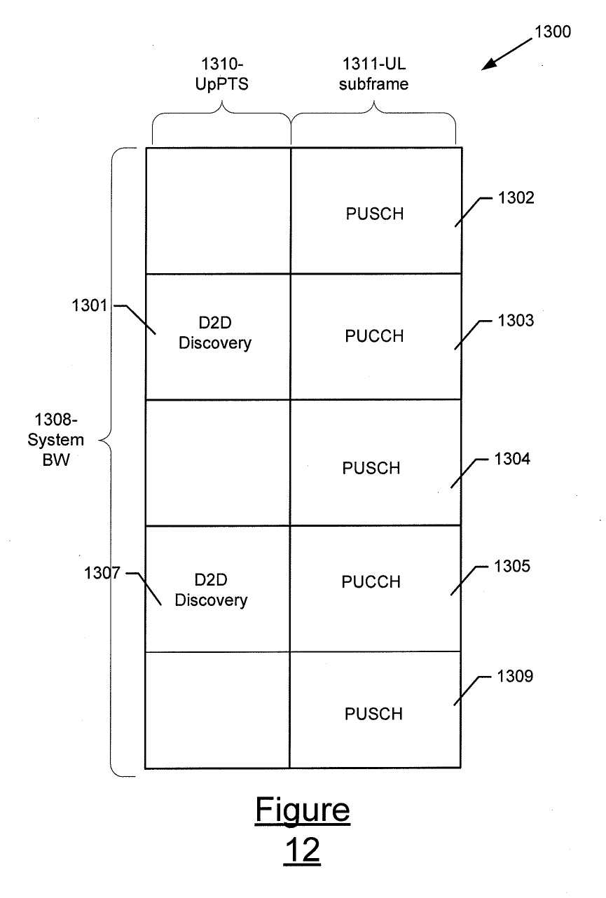

FIG. 12 is a block diagram of additional bandwidth allocations in accordance with several embodiments of the present invention. As shown in FIG. 12, time window 1300 is divided into UpPTS 1310 and uplink (UL) subframe 1311. Within the UpPTS, two resource slots are allocated for D2D discovery, 1301 upper and 1307 lower in the system bandwidth (BW) 1308.

The system bandwidth (BW) 1308 in the UL subframe 1311 comprises PUSCH and PUCCH in a stack configuration. For example, as shown in FIG. 12, PUSCH 1302 is allocated at the top of the UL subframe 1311, and PUSCH 1307 is located at the bottom of the UL subframe 1311. As shown in FIG. 12, PUCCH 1303 and PUCCH 1305 are allocated closer to the center of system bandwidth 1308. PUSCH 1304 is allocated in between PUCCH 1303 and PUCCH 1305.

The various example embodiments of the present invention are beneficial for a number of reasons. For example, by determining which bandwidth is not being used, and allocating such bandwidth for D2D discovery purposes, the various embodiments of the present invention further increase bandwidth efficiency. Further, by providing for such information on available bandwidth, the base station in such communication networks as LTE/LTE-Advanced which provide for D2D communications may further control and monitor D2D communications in the network, thereby supporting D2D communications which may increase network utilization and efficiency.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A method comprising:
initiating a device to device (D2D) discovery function between a first device and a second device;
ascertaining available bandwidth in a time slot;
determining a length of the time slot; and
allocating a D2D discovery portion for a D2D connection based at least in part on the available bandwidth and the length of the time slot.

2. The method of claim 1, wherein available system bandwidth comprises bandwidth mapped to a physical random access channel (PRACH).

3. The method of claim 1, wherein available bandwidth comprises sounding reference signal (SRS) uplink bandwidth.

4. The method of claim 1, wherein determining comprises determining a symbol length of the time slot.

5. The method of claim 1, wherein the time slot is an uplink pilot time slot.

6. The method of claim 1, wherein the first device or the second device is a mobile terminal.

7. The method of claim 1, wherein allocating comprises allocating a D2D discovery portion at the edge of the available bandwidth.

8. A method comprising:
allocating a first portion of system bandwidth in a timeslot for resources for supporting device to device (D2D) discovery by a first device; and designating a second portion of the system bandwidth in the timeslot for resources for supporting D2D discovery by a second device such that the first and second devices are configured for D2D communication;
wherein the first portion and the second portion are separated by bandwidth allocated for other resources.

9. The method of claim 8, wherein the bandwidth allocated for other resources comprises bandwidth mapped in the frequency domain.

10. The method of claim 8, wherein the timeslot comprises an uplink pilot time slot (UpPTS).

11. The method of claim 8, wherein the first device or the second device comprises a mobile terminal.

12. The method of claim 8, wherein allocating comprises allocating a first portion of system bandwidth at the edge of the system bandwidth.

13. The method of claim 8, wherein designating comprises designating a second portion of system bandwidth at the edge of the system bandwidth.

14. An apparatus comprising:
at least one processor; and
at least one memory including computer program code, the at least one memory and the computer program code configured to, with the at least one processor, cause the apparatus at least to:
initiate a device to device (D2D) discovery function between a first device and a second device;
ascertain available bandwidth in a time slot;
determine a length of the time slot; and
allocate a D2D discovery portion for a D2D connection based at least in part on the available bandwidth and the length of the time slot.

15. The apparatus of claim 14, wherein the available system bandwidth comprises bandwidth mapped to a physical random access channel (PRACH).

16. The apparatus of claim 14, wherein available bandwidth comprises sounding reference signal (SRS) uplink bandwidth in a broadcast channel (BCH).

17. The apparatus of claim 14, wherein the at least one memory and the computer program code are configured to, with the at least one processor, cause the apparatus to determine a symbol length of the time slot.

18. The apparatus of claim 14, wherein the time slot comprises an uplink pilot time slot.

19. The apparatus of claim 14, wherein the first device or the second device comprises a mobile terminal.

20. An apparatus comprising:
at least one processor; and
at least one memory including computer program code, the at least one memory and the computer program code configured to, with the at least one processor, cause the apparatus at least to:
allocate a first portion of system bandwidth in a timeslot for resources for supporting device to device (D2D) discovery by a first device; and
designate a second portion of the system bandwidth in the timeslot for resources for supporting D2D discovery by a second device such that the first and second devices are configured for D2D communication;
wherein the first portion and the second portion are separated by bandwidth allocated for other resources.

21. The apparatus of claim 20, wherein the bandwidth allocated for other resources comprises PUCCH bandwidth.

22. The apparatus of claim 20, wherein the time slot comprises an uplink pilot time slot (UpPTS).

23. The apparatus of claim 20, wherein the first device or the second device comprises a mobile terminal.

24. The apparatus of claim 20, wherein the at least one memory including computer program code, the at least one memory and the computer program code are further configured to, with the at least one processor, cause the apparatus at least to allocate a first portion of system bandwidth at the edge of the system bandwidth.

25. The apparatus of claim 20, wherein the at least one memory including computer program code, the at least one memory and the computer program code are further configured to, with the at least one processor, cause the apparatus to designate comprises designating a second portion of system bandwidth at the edge of the system bandwidth.
